(19) United States
(12) Patent Application Publication
(10) Pub. No.: US 2003/0132389 A1
(43) Pub. Date: Jul. 17, 2003

(54) Method for monitoring and controlling the high temperature reducing combustion atmosphere

(76) Inventors: William A. Von Drasek, Oak Forest, IL (US); Shawn D. Wehe, Shirley, MA (US); Mark G. Allen, Boston, MA (US)

Correspondence Address: Air Liquide, Intellectual Property Law Department, Ste. 1800, 2700 Post Oak Blvd., Houston, TX, 77056, US

(21) Appl. No.: 10/314,566

(22) Filed: Dec. 9, 2002

Related U.S. Application Data
(60) Provisional application No. 60/349,638, filed on Jan. 17, 2002.

(51) Int. Cl. G01J 5/02

(52) U.S. Cl. 250/343; 250/339.04

(57) ABSTRACT

A method for monitoring the high temperature reducing combustion atmosphere in a combustion process is disclosed. First, a spectral region for monitoring CO and H₂O is identified. A laser wavelength is scanned so that a complete absorption transition includes a portion of the baseline. A laser is then referenced to an ITU-GRID. An output signal is generated from the laser and directed to a coupler to split the output signal in a predetermined ratio to a first component and a second component. The first component is directed to optics where it is shaped and collimated and then directed across a sample to be monitored to a detector that generates a measured output. The second component is directed to an absorption measurement device. The measured output is compared with the second component, and the temperature of the atmosphere and the concentration of the CO present in the atmosphere is calculated.

### CROSS REFERENCE TO RELATED APPLICATION

This application claims the benefit of U.S. Provisional Application No. 60/349,638, filed Jan. 17, 2002.

### BACKGROUND OF THE INVENTION

1. Field of the Invention

A method for monitoring the high temperature reducing combustion atmosphere in a combustion process is disclosed. First, a spectral region for monitoring CO and H₂O is identified. A laser wavelength is scanned so that a complete absorption transition includes a portion of the baseline. A laser is then referenced to an ITU-GRID. An output signal is generated from the laser and directed to a coupler to split the output signal in a predetermined ratio to a first component and a second component. The first component is directed to optics where it is shaped and collimated and then directed across a sample to be monitored to a detector that generates a measured output. The second component is directed to an absorption measurement device. The measured output is compared with the second component, and the temperature of the atmosphere and the concentration of the CO present in the atmosphere is calculated.

In a preferred embodiment, a single, tunable diode laser is selected to enable monitoring of two H₂O absorption lines and a single CO absorption line in the 1.56 μm spectral region. Detection of multiple H₂O lines provides information on the process gas temperature that is used for determining the CO concentration. This approach is advantageous for dynamic process monitoring, particularly in high temperature combustion processes that require real-time monitoring of CO. In addition, the laser is aligned with an ITU-GRID channel in the c-band, thus allowing the implementation of standard telecommunication lasers for process gas monitoring. The compatibility of this spectral region with erbium doped fiber amplifiers permits increased laser power, thereby extending the use for sensor applications in multiplexing systems and improving transmission through high particle density processes.

2. Description of the Prior Art

The capability to measure the products of incomplete combustion (PICs) provides a means to control the desired level of the reducing gas atmosphere that can influence safety, energy efficiency, pollutant control, or product quality. One of the key species associated with PICs is CO, which provides a measure of the combustion atmosphere reducing level.

For some processes, such as colored glass melting and heat treating, the level of the reducing atmosphere can impact product quality. In the case of steel heat treating, the CO level is controlled to maintain the desired carbon level, whereas the final product color for glass melting is dependent on the reducing level of the gas atmosphere. For other processes, such as electric arc furnaces (EAF) for secondary steel melting, CO is exhausted from the process and represents lost chemical energy. The ability to monitor CO and recover the chemical energy through controlled O₂ injection on the EAF has been demonstrated to improve the energy efficiency by five to ten percent. In addition, when CO is monitored in combination with CO₂ on the EAF, information on the carbon balance of the steel melt is ascertained. These examples illustrate the importance of CO monitoring, along with the broad range of applications where the reducing level of the combustion atmosphere is important to monitor for process optimization.

Process monitoring of CO has been traditionally performed using extractive sampling probes that are water-cooled and inserted into the process. The sequence of events in extractive gas sampling are as follows: 1) a gas sample is pulled through the probe inserted into the process quenching the reaction mixture; 2) passed through a chiller for water removal; 3) passed through a filter for particle removal; 4) compressed by the sampling pump; and 5) directed through an analyzer for measuring the dry CO concentration level. The analyzer used typically consists of one of the following types: a gas chromatograph, mass spectrometer, non-dispersive infrared analyzer or dispersive infrared analyzer.

Gas chromatographs perform a batch analysis and therefore have the slowest response time from the techniques listed. Mass spectrometers provide continuous monitoring with fast-response times but are sensitive to dirty gases steams and interpretation of the mass spectra is complicated by overlapping mass fragments. This is most evident when interpreting spectra containing CO and N₂ species since both have the same atomic mass unit. For these reasons either dispersive or non-dispersive IR analyzers are generally used. Though extractive sampling has a long history and is an accepted practice for many combustion applications, disadvantages such as slow response time, susceptibility to probe plugging and corrosion, and being a single point measurement, hampers acceptance of this approach as a continuous means for process monitoring.

Alternatives to extractive sampling include continuous CO monitoring instruments. Considered to be in situ, these employ a catalytic approach that can operate at temperatures up to 1500° C., e.g., the Ametek Thermox (Pittsburgh, Pa.) WDG-HPIIC. However, this approach does not always permit distinguishing between CO and combustibles that may be present. In addition, the instrument response time is relatively slow, and can be typically about 25 seconds for a 63% process step change. Moreover, this approach provides a single point measurement.

Another in situ detection method for CO by absorption involves launching a collimated beam of radiation across the process, tuned at an absorption transition frequency, and measuring the amount of radiation absorbed by the medium. In this method, line-of-sight optical access is required, and the measurement result is the average concentration of CO along the path of beam propagation. For industrial process monitoring, this technique offers a number of advantages due to the non-intrusive nature; thus, issues related to sampling probe plugging and corrosion are not experienced. The resulting measurement is an average of the concentration the within the beam volume which can provide a truer representation of the process gas composition. In addition, in situ absorption measurements are optical based techniques and, at least in theory, have no temperature limitation.

For combustion monitoring applications, absorption of CO in either the mid-infrared or the near infrared spectral region is generally used. In the UV spectral region, CO can also be monitored by accessing the Cameron band system a³II-X¹Σ⁺ (1765-2155 A). Okabe, H., PHOTO-CHEMISTRY OF SMALL MOLECULES, John Wiley & Sons, New York (1978), at page 166. However, this spectral region is difficult to access with a light source requiring UV optics, and will exhibit higher sensitivity to the presence of particulates compared to the mid or near IR spectral region, thereby minimizing the efficacy of this method in an industrial process.

An in situ measurement method by Advanced Fuel Research (East Hartford, Conn.) uses an incoherent broadband IR light source directed through a medium, and collects the beam with a dispersive instrument. Species concentrations are obtained from the recorded absorption, emission or combined absorption/emission spectra are acquired and gas temperatures are obtained from the band shapes. Though the technique provides a great deal of information, industrial acceptance has been hampered by the complexity of the system. A disadvantage of this technique is low spectral resolution, 0.5 to 1 cm⁻¹, resulting in overlapping transitions. Another disadvantage of this technique is the need for calibration at high temperatures. The complexity of interfacing the system close to the process, moderate time responses, and the complexity of analyzing the data are other disadvantages that have hampered the efficacy of this technique in an industrial setting.

Diode laser technology has emerged that provides a source of tunable laser light usable in industrial environments. This approach offers numerous benefits for monitoring applications compared to the previously discussed techniques. The devices are broadly tuned with temperature, and fine-tuned by ramping the injection current to sweep across an isolated absorption transition. Laser sweep frequencies as high as 1000 Hz are obtainable, Allen, M. G., DIODE LASER ABSORPTION SENSORS FOR GAS-DYNAMIC AND COMBUSTION FLOWS, Measurement Science and Technology, Vol. 9, pg. 545-562 (1998), with 500-100 Hz being typical, thus providing real-time process monitor capability even when spectral averaging is used. The lasers operate at single mode, with line widths on the order of 10-100 MHz, much narrower than the high temperature absorption line widths (4-5 GHz) of typical combustion gas species. These characteristics give the light source a much greater specificity and sensitivity than broadband light source instruments.

The numerous advantageous that diode lasers offer have led to the development and testing of a variety of sensor systems for industrial applications. Common to the various approaches is measuring both the gas temperature and gas composition. For example, U.S. Pat. No. 5,984,998 discloses using diode lasers to monitor the off-gas on a steel making process, which contains CO at high temperatures. However, in that disclosure, the measurements are focused on the mid-infrared spectral region. Two different wavelength regions are analyzed, one near 2090 cm⁻¹ for CO and CO₂ monitoring, and the other near 2111 cm⁻¹ for₂ H O monitoring. Gas temperature and concentration are determined by spectral fitting. This spectral region offers higher sensitivity (perhaps 100 to 1000 times) than NIR, but requires the use of lasers operating at cryogenic temperature. In addition, the MIR wavelength region is not compatible with fiber components, thereby complicating beam delivery in harsh environments and requiring the lasers and associated electronics to be located close to the process. Measurements have been demonstrated on EAF, Allendorf, et al., LASER-BASED SENSOR OF OFFGAS COMPOSITION AND TEMPERATURE IN BOF STEELMAKING, Iron and Steel Engineer, vol. 74, pg. 31-35 (1998), but the need for cryogenic cooling and lack of fiber compatibility limit the feasibility of this approach as a routine measurement in many industrial settings.

U.S. Pat. No. 5,813,767, by Calabro, et al. of Finmeccanica S.p.A., describes a multiple laser system for waste incineration monitoring. In particular, the reference discloses a method of determining the temperature from the Gaussian component of the recorded spectral line based on identifying the Doppler contribution, which depends solely on the temperature. This approach is seen to have limited use since extremely high quality data is required. For applications on industrial processes that experience high particle densities, temperature gradients, mechanical vibration, rapid variations in temperature and gas composition, and high radiation loads from the process itself, this method is not deemed feasible. These industrial environmental effects will degrade the quality of the spectrum, thus introducing errors.

In U.S. Pat. No. 5,832,842, by Frontini, et al. of Finmeccanica S.p.A., a plurality of lasers for CO, O₂, H₂O and HCl monitoring the combustion fumes composition from incineration plants to control the fume acidity is disclosed.

One drawback with DFB lasers is the narrow tuning range achievable through varying the injection current, typically 1-3 cm⁻¹. This limits the number of species that can be monitored with a single laser. Extension of the tuning range over several nanometers can be obtained by varying the device temperature, but this method sacrifices the speed at which multiple spectral regions can be monitored due to the time required for the laser to become thermally stable. External cavity lasers such as those offered by New Focus (San Jose, Calif.) operate with a broader tuning range, e.g., model 6328 has tuning range of 1520-1570 nm, with tuning speed of 10 nm/s, but these sacrifice speed. Therefore, applications requiring multiple species monitoring, as required in high temperature processes where the temperature is not known or is varying, require several DFB lasers, as suggested by Frontini et al., to maintain a fast-response time.

Examples implementing multiple DFB lasers where both temperature and concentration are required is shown in Ebert, et al., SIMULTANEOUS DIODE-LASER-BASED IN SITU DETECTION OF MULTIPLE SPECIES AND TEMPERATURE IN GAS-FIRED POWER PLANT, Proceedings of the Combustion Institute, Vol. 28, pp. 423-430 (2000). These appear to function on a 1 GW gas-fired power plant monitoring. Another example, disclosed in Furlong, et al., DIODE-LASER SENSORS FOR REAL-TIME CONTROL OF TEMPERATURE AND H₂O IN PULSED COMBUSTION SYSTEMS, 34th AIAA/ASME/SAE/ASEE Joint Propulsion Conference, AIAA-98-3949 (1998), appears to function on a pulsed waste incinerator. In both cases, the integration of multiple lasers into a system adds complexity to the system, by requiring additional wavelength discriminating means for the different laser wavelengths.

An alternative approach to replace multiple DFB lasers is disclosed in Upschulte, et al., IN SITU MULTI-SPECIES COMBUSTION SENSOR USING A MULTI-SECTION DIODE LASER, 36th Aerospace Sciences Meeting & Exhibit, Reno, Nev., AIAA 98-0402 (1998). This approach demonstrates multi-species monitoring using a single multi-section diode laser for simultaneous detection of CO, H₂O and OH in laboratory flame exhaust gases. The lasers fast scanning capability can access any wavelength within a 40 nm band in approximately 1 μs. However, these lasers are difficult to manufacture relative to standard DFB designs, operate at lower powers, and require special control systems adding cost and complexity to the system.

Thus, a problem associated with methods for monitoring and controlling the high temperature reducing combustion atmosphere in a combustion process that precede the present invention is that they provide a slow response time and thereby do not adequately indicate process conditions to enable optimal process control.

Yet another problem associated with methods for monitoring and controlling the high temperature reducing combustion atmosphere in a combustion process that precede the present invention is that they are susceptible to probe plugging and corrosion.

Still another problem associated with methods for monitoring and controlling the high temperature reducing combustion atmosphere in a combustion process that precede the present invention is that they provide only a single point measurement, thereby hampering their acceptability as a continuous means for process monitoring.

An even further a problem associated with methods for monitoring and controlling the high temperature reducing combustion atmosphere in a combustion process that precede the present invention is that they do not permit a reliable means to distinguish between CO and combustibles that may be present.

Yet another problem associated with methods for monitoring and controlling the high temperature reducing combustion atmosphere in a combustion process that precede the present invention is that they utilize a spectral region that is difficult to access with a light source requiring UV optics, and will therefore be sensitive to the presence of particulates.

Still another problem associated with methods for monitoring and controlling the high temperature reducing combustion atmosphere in a combustion process that precede the present invention is that they require the use of lasers operating at cryogenic temperature, thereby requiring cryogenic cooling.

An even further a problem associated with methods for monitoring and controlling the high temperature reducing combustion atmosphere in a combustion process that precede the present invention is that they utilize an MIR wavelength region that is not compatible with fiber optic components, thereby complicating beam delivery in harsh environments.

Yet another problem associated with methods for monitoring and controlling the high temperature reducing combustion atmosphere in a combustion process that precede the present invention is that they cannot be used in industrial processes that experience high particle densities, temperature gradients, mechanical vibration, rapid variations in temperature and gas composition, and high radiation loads from the process itself Still another problem associated with methods for monitoring and controlling the high temperature reducing combustion atmosphere in a combustion process that precede the present invention is that they have a complex electromechanical structure, are expensive to construct and difficult to maintain.

In contrast to the foregoing, the present invention provides a method and apparatus for monitoring and controlling the high temperature reducing combustion atmosphere in a combustion process that seeks to overcome the foregoing problems and provide a more simplistic, more easily constructed and relatively reliable methodology.

### SUMMARY OF THE INVENTION

A method for monitoring the high temperature reducing combustion atmosphere in a combustion process is disclosed. First, a spectral region for monitoring CO and H₂O is identified. A laser wavelength is scanned so that a complete absorption transition includes a portion of the baseline. A laser is then referenced to an ITU-GRID. An output signal is generated from the laser and directed to a coupler to split the output signal in a predetermined ratio to a first component and a second component. The first component is directed to optics where it is shaped and collimated and then directed across a sample to be monitored to a detector that generates a measured output. The second component is directed to an absorption measurement device. The measured output is compared with the second component, and the temperature of the atmosphere and the concentration of the CO present in the atmosphere is calculated.

In a preferred embodiment of the present invention, a set of absorption lines for (2) H₂O (6405.92 and 6406.53 cm⁻¹) and (1) CO (6406.7 cm⁻¹) are uniquely defined over a narrow spectral interval such that a single DFB laser can access the three lines in a single sweep of the laser wavelength. Laser output frequency is expressed by vacuum wave numbers, cm⁻¹. Measurements of the gas temperature are obtained from the two H₂O lines, thereby providing a means for determining the CO concentration. The absorption lines selected are near an ITU-GRID (International Telecommunication Union) channel 21, thus eliminating the need for a custom wavelength laser. In addition, the wavelength region selected corresponds to the c-band (conventional band 1.528-1.563 μm region) as defined by the ITU, providing compatibility for use with fiber amplifiers, e.g., erbium doped, that can boost laser power by several orders of magnitude. These aspects of the invention will be more fully explained in the detailed description of preferred embodiments, infra.

Thus, an object of the present invention is to provide a method for monitoring and controlling the high temperature reducing combustion atmosphere in a combustion process that provides a fast response time and thereby adequately indicates process conditions to enable optimal process control.

Yet another object of the present invention is to provide a method for monitoring and controlling the high temperature reducing combustion atmosphere in a combustion process that is not susceptible to probe plugging and corrosion.

Still another object of the present invention is to provide a method for monitoring and controlling the high temperature reducing combustion atmosphere in a combustion process that provides a broader measurement base, thereby enhancing its acceptability as a continuous means for process monitoring.

An even further object of the present invention is to provide a method for monitoring and controlling the high temperature reducing combustion atmosphere in a combustion process that provides a reliable means to distinguish between CO and combustibles that may be present.

Yet another object of the present invention is to provide a method for monitoring and controlling the high temperature reducing combustion atmosphere in a combustion process that is less sensitive to the presence of particulates.

Still another object of the present invention is to provide a method for monitoring and controlling the high temperature reducing combustion atmosphere in a combustion process that does not require the use of lasers operating at cryogenic temperature, thereby eliminating the need for cryogenic cooling.

An even further object of the present invention is to provide a method for monitoring and controlling the high temperature reducing combustion atmosphere in a combustion process that utilizes a wavelength region that is compatible with fiber optic components, thereby simplifying beam delivery in harsh environments.

Yet another object of the present invention is to provide a method for monitoring and controlling the high temperature reducing combustion atmosphere in a combustion process that can be used in industrial processes that experience high particle densities, temperature gradients, mechanical vibration, rapid variations in temperature and gas composition, and high radiation loads from the process itself.

Still another object of the present invention is to provide a method for monitoring and controlling the high temperature reducing combustion atmosphere in a combustion process that has a more simple electromechanical structure, is relatively inexpensive to construct and more easily maintained.

These and other objects, advantages and features of the present invention will be apparent from the detailed description that follows.

### BRIEF DESCRIPTION OF THE DRAWINGS

In the detailed description that follows, reference will be made to the following figures:

FIG. 1 illustrates the spectral region overlap with the overtone roto-vibrational absorption lines for CO and combination lines for H₂O;

FIG. 2 illustrates spectral data using HITRAN-HITEMP database over a spectral interval of 6405-6410 cm⁻¹;

FIG. 3 is a graphical representation of expected data illustrating temperature sensitivity over 1100-2200 K;

FIG. 4 illustrates the temperature dependence of the linestrength S(T) for the (3,0) R20 and the (4,1) R33 data;

FIG. 5 illustrates a preferred embodiment of an apparatus and method for use in monitoring a combustion process;

FIG. 6 illustrates expected data from targeted absorption transitions;

FIG. 7 illustrates another preferred embodiment of an apparatus and method for use in monitoring a combustion process;

FIG. 8 illustrates another preferred embodiment of an apparatus and method for use in monitoring a combustion process; and

FIG. 9 illustrates still another preferred embodiment of an apparatus and method for use in monitoring a combustion process when beam movement or line-of-sight access is problematic.

### DETAILED DESCRIPTION OF PREFERRED EMBODIMENTS

In a preferred embodiment, unique spectral regions for monitoring CO (6406.7 cm⁻¹) and H₂O (6405.92 and 6406.53 cm⁻¹) are identified for application on high temperature combustion processes. The selected spectral region is particularly applicable to processes that are at temperatures between 1000-2500 K and dynamic, e.g., EAF or secondary Al melting furnaces. The dynamic nature of these processes results in large gas temperature and gas composition variations over time periods as short as a single second. The fast scanning capability of the tunable diode laser, in combination with the narrow spectral window identified for CO and H₂O monitoring, allows process variations to be detected at time responses that are considered real-time (times of less than one second) for industrial processes. The combination of CO and H₂O monitoring provides a means to extract both gas temperature and concentration simultaneously from the absorption spectra measured along the same path. This feature is beneficial since the resulting absorption signal recorded is dependent on temperature through the absorption coefficient that appears in the Beer-Lambert law as the product of the line strength and line shape functions.

Applicants hereby incorporate by reference the disclosure of their copending U.S. patent application entitled “Apparatus and Method for Launching and Receiving a Broad Wavelength Range Source,” filed Nov. 14, 2002 and bearing Ser. No. 10/294,061 (Applicants' Docket No. S-5858). The Beer-Lambert relation describes the resulting absorption of the laser radiation along the measurement path for a single species given by:

I_{V}=I_{v,o}e^{[-S(T)g(v-v}^{ₒ}^{)Nl]} (1)

where Iᵥ is the laser intensity at frequency v measured after the beam has propagated across a path l with N absorbing molecules per volume. The incident laser intensity is I_{v,o} and is referred to as the reference. The amount of laser radiation attenuated is determined by the temperature dependent line strength S(T) and the line shape function g(v−vₒ,). Inversion of Eq. 1 relates the number density N to the measured laser intensities and known line strength and path length given by:

$$N = \frac{1}{S ( T ) l} \int ln ( \frac{{I}_{vo}}{{I}_{v}} ) ⅆ v \qquad ( 2 )$$

With the exception of S(T) in Eq. 2 the parameters are either measured or known. If the process temperature is relatively constant, then S(T) can be taken as constant from either calibration measurements or from validated database values, e.g., HITRAN-HITEMP, (see Rothman, et al., THE HITRAN MOLECULAR DATABASE: EDITIONS OF 1991 AND 1992, J. Quant. Spectrosc. Radiat. Transfer., 48,469-507). For processes that undergo temperature variations, a means of obtaining the gas temperature to determine the correct value of S(T) is required. On slow temperature varying processes, temperature information can be obtained from the refractory wall temperature by either thermocouple or optical pyrometer measurements in particle free systems. However, on a dynamic process, the response time of wall temperatures is too slow for an accurate determination of S(T). Therefore, an alternative means for obtaining the temperature is needed for real-time process monitoring.

Suction pyrometer (SP) probes provide one method for measuring process gases up 1800 K, but typical response times (about 30 to 120 seconds) are unacceptably slow. For process temperatures greater than 1800 K, a higher temperature suction pyrometer (T as high as about 2200 K) using a water-cooled probe tip, such as the International Flame Research Foundations probe, extends the temperature range. However, the response times are still unacceptably slow.

A disadvantage associated with using SP probes is that the measurement obtained is a single point, whereas the TDL measurement is path averaged. In this case, large errors can be introduced if the temperature distribution is not homogenous along the path. As pathlength increases, the error introduced between a point and path-averaged measurement can also increase. The greatest drawback with using a SP measurement is found in high particle density processes, since the gas is drawn from the process with the flow directed over a thermocouple. Particles can build up on the thermocouple surface, effecting the measurement by changing the thermal conductivity. In addition, the SP point measurement requires additional access to the process that may not be possible. The preferred approach is to conduct a path-averaged temperature measurement to determine S(T) along the same path that the CO absorption is being measured.

Gas temperatures can be measured from the absorbance spectrum if multiple rotational lines are detected within the scanning range of a single or multiple diode laser system. The area-ratio of the integrated absorbance of each transition is related to the temperature by:

$$R ( T ) = \frac{{S}_{0 , 1}}{{S}_{0 , 2}} exp [ \frac{hc}{k} \frac{{E}_{2}^{′′} - {E}_{1}^{′′}}{T - {T}_{0}} ] \qquad ( 3 )$$

where R(T) is the ratio of the integrated absorbance at each transition at the unknown temperature, S_{o,1} is the line strength at a reference temperature, Tₒ of line I, is its lower state energy. Thus, the equation can be rearranged to solve for temperature:

$$T = \frac{\frac{hc}{k} ( {E}_{2}^{′′} - {E}_{1}^{′′} )}{ln ( R ( T ) \cdot \frac{{S}_{0 , 2}}{{S}_{0 , 1}} )} . \qquad ( 4 )$$

Examples using the area-ratio technique for temperature monitoring found in the literature focus on using H₂O as the probe species in the 1.31 μm region as shown by Upshulte et al. (see Upschulte, et al., DIODE LASER MEASUREMENTS OF LINE STRENGTHS AND SELF-BROADENING PARAMETERS OF WATER VAPOR BETWEEN 300 AND 1000 K NEAR 1.31 MM, J. Quant. Spectrosc. Radiat. Transfer, vol. 59, 6, pg. 653-670 (1998)) or near 0.820 μm, as shown by Ebert, et al., SIMULTANEOUS DIODE-LASER-BASED IN SITU DETECTION OF MULTIPLE SPECIES AND TEMPERATURE IN GAS-FIRED POWER PLANT, Proceedings of the Combustion Institute, Vol. 28, pp. 423-430 (2000). Additionally, gas temperature monitoring from a hot gas stream has been demonstrated by monitoring 2 rotational lines of O₂ in the 760 nm spectral region with comparative measurements using conventional SP. Von Drasek, et al., MULTI-FUNCTIONAL INDUSTRIAL COMBUSTION PROCESS MONITORING WITH TUNABLE DIODE LASERS, Proceedings of SPIE, Vol. 4201 (2000). However, the presence of O₂ is dependent on the operating conditions and under reducing conditions, O₂ will not be present. Therefore, H₂O is the preferred thermometry species due to its abundance in the combustion atmosphere independent of fuel-lean or fuel-rich operating conditions.

As discussed previously, standard distributed feedback diode lasers are grossly tuned by temperature and then fine-tuned by varying the injection current to the laser. The preferred method of operation is to scan the laser wavelength such that a complete absorption transition including a portion of the baseline is detected. The baseline is useful in determining the contribution from broadband absorbers or scatters that may be present in the process stream. In addition, resolving the entire true line shape and applying a scan and integrate technique (see Allen, M. G., DIODE LASER ABSORPTION SENSORS FOR GAS-DYNAMIC AND COMBUSTION FLOWS, Measurement Science and Technology, Vol. 9, pg. 545-562 (1998)) eliminates effects due to Doppler or collisional broadening. Modulation techniques such as FM (frequency modulation) or WM (wavelength modulation) can be used to improve SNR (signal-to-noise ratio), but extensive calibration and knowledge of the surrounding gas composition are required to address the broadening effects. Nevertheless, whether a scan and integrate or modulation technique is used the scanning range of the laser is limited to 1-2 cm⁻¹.

Use of diode laser techniques for gas sensing applications has been limited partly due to laser availability. Until recently, many of the lasers that find broad industrial applications ranging from CD-players, laser pointers, and optical transmitters emit at wavelengths that are not in line with absorption of molecular species of interest. Therefore, custom laser manufacturing is required to access wavelength regions of interest.

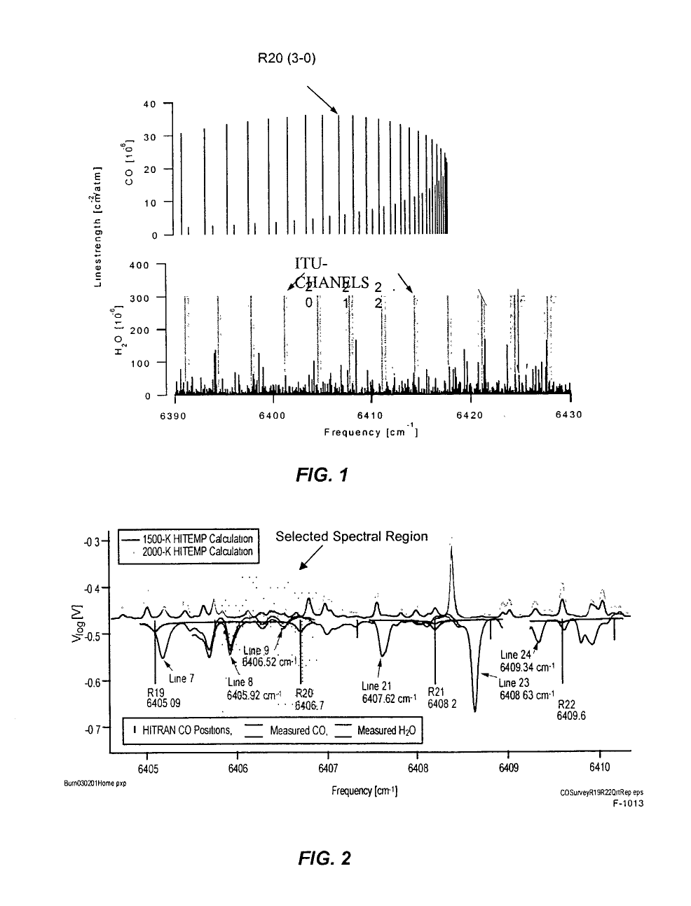

In the 1.55 μm spectral region, specifically 1.528-1.563 μm, the International Telecommunication Union (ITU) has recommended a defined grid of standard wavelengths denoted as the C-band (conventional band) with a frequency spacing of 50 or 100 GHz as recommended in ITU-T G.692 document. The spectral region was selected to take advantage of the high performance obtained with erbium-doped fiber amplifier (EDFA) for long distance transmission. In addition, this spectral region overlaps with the overtone roto-vibrational absorption lines for CO and combination lines for H₂O as shown in FIG. 1. Here only a portion of the c-band is shown with the corresponding ITU channels that overlap with the R branch of the 2^{nd} vibrational overtone band of CO on the top plot and overtone and combination H₂ O lines on the bottom plot. Therefore, laser selections can be made to match telecommunication lasers insuring availability, quality, and reliability. For the wavelengths defined here a standard laser, e.g., AIFOtec Inc. of Middletown, Pa. specified at channel 21 sits only 0.256 cm⁻¹ away from selected CO (6406.7 cm⁻¹) transition.

Determination of this optimum set of lines required setting criteria based on absorbance strength, baseline quality, temperature sensitivity, and proximity to a neighboring CO absorption transition. For achieving sufficient measurement, sensitivity the absorbance strength must be greater than the noise level of the detection system. The value of the minimum absorbance strength is dependent on the expected temperature range, concentration range, pathlength, and line broadening. A spectrum with having good quality baseline allows unique identification of the isolated lines that are not overlapped. This allows easy selection of the line for applying a scan-and integrate approach for real-time analysis. For temperature monitoring the line pair must be sensitive to temperature over the range of interest. The temperature sensitivity obtained is set by the lower state energy separation appearing in Eq. (2), as E″₂−E″₁. Finally, if the above criteria are meet for the H₂O line pair these lines must reside in close proximity to a CO line that also poses a strong absorption over the temperature range of interest, thereby allowing the use of a single DFB laser.

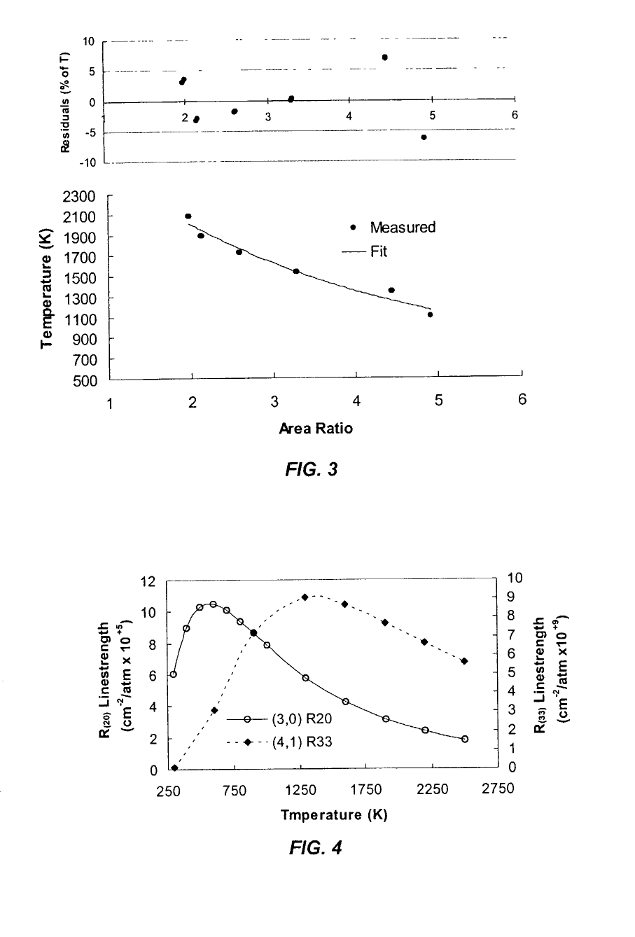

A spectral survey using HITRAN-HITEMP database over a spectral interval of 6350-6550 cm⁻¹ shows more than 28,000 possible water lines accessible in this spectral region. Upon applying the selection criteria outlined above the possible choice for line combinations quickly decreases to a select few candidates. Absolute line selection is obtained from experimental spectral survey, since known errors in line position and line strength are known to exist in HITRAN-HITEMP for high temperatures. Result of the spectral survey that uniquely identifies the lines meeting the criteria outlined is shown in FIG. 2 with the H₂O lines identified as line 8 and line 9. An R20 CO line accessible near the H₂O is also identified on FIG. 2. Quantum numbers for the H₂O lines are not known since the partition of energy at high temperatures in the different modes is an extremely complicated problem. Nevertheless, the experiments uniquely identify these lines as H₂O and demonstrate the temperature sensitivity over 1100-2200 K, as shown in FIG. 3. Furthermore, the data can be fit to an empirical exponential function given by

T(R)=A+Bexp^{(-CR)}+Dexp^{(-ER)} (5)

where A, B, C, D and E are constants, which can easily be incorporated into the systems data processing algorithm for real-time temperature monitoring. Results of the fit through the data show an error of less than about 5 percent at the higher temperature end, and less than about 8 percent at te low temperature end. The resulting expression can easily by used in the acquisition control system for quick temperature determination. Once the temperature is determined, the linestrength for the (3,0) R20 line is obtained from an empirical fit of S(T) over a selected temperature range, e.g., 1100-2200 K in this case. The temperature dependence of the linestrength, S(T) for the (3,0) R20 line is shown in FIG. 4. The measured CO number density is then obtained by applying Eq. 2 to the integrated absorbance of the (3,0) R20 CO line.

In Thomson, et al., LASER BASED OPTICAL MEASUREMENTS OF ELECTRIC ARC FURNACE OFF-GAS FOR POLLUTION CONTROL AND ENERGY EFFICIENCY, Innovative Technologies for Steel and Other Materials, Met. Soc., The Conference of Metallurgists, Toronto (August 2000), calibration results are presented for multiple H₂O and CO line detection near 1.577 μm region using a jump scanning technique described in Fried, et al., TUNABLE DIODE LASER RATIO MEASUREMENTS OF ATMOSPHERIC CONSTITUENTS BY EMPLOYING DUAL FITTING ANALYSIS AND JUMP SCANNING, Applied Optics, 33, 6, pg. 821-827 (1993). This work identifies a combination of the (4,1) R33 CO line at 1577.96 nm (6418.65 cm⁻¹) along with H₂O lines at 1577.8 (6337.94 cm⁻¹) and 1578.1 nm (6336.73 cm⁻¹) that can be accessed by jump scanning the laser. Here the tuning range of the laser is over 1.2 cm⁻¹ if a portion of the baseline measurement is also included. In addition, the combination (4,1) R33 CO line has a weak linestrength compared with the (3,0) R20 line, as seen from FIG. 4. The weak linestrength will limit the sensitivity of the measurement to higher CO concentrations or longer pathlength measurements. For these reasons, the preferred spectral region for monitoring high temperature processes is between 6406.7 cm⁻¹ and 6405.92 cm⁻¹.

Laser selection aligned with the ITU-GRID facilitates using standard amplification devices, such as an erbium-doped fiber amplifier (EDFA), designed for use on the c or L bands defined by ITU. These devices provide low noise amplification of several orders of magnitude. For gas sensing applications on high particle density processes, such as EAF's, or on moderate particle densities in combination with long pathlengths, severe attenuation of the laser power through process can occur. Depending on the amount of laser power reduction, the measurement quality, i.e., SNR, and/or measurement time is increased. The effect on measurement time refers to the necessary increased averaging that would be required to improve the SNR.

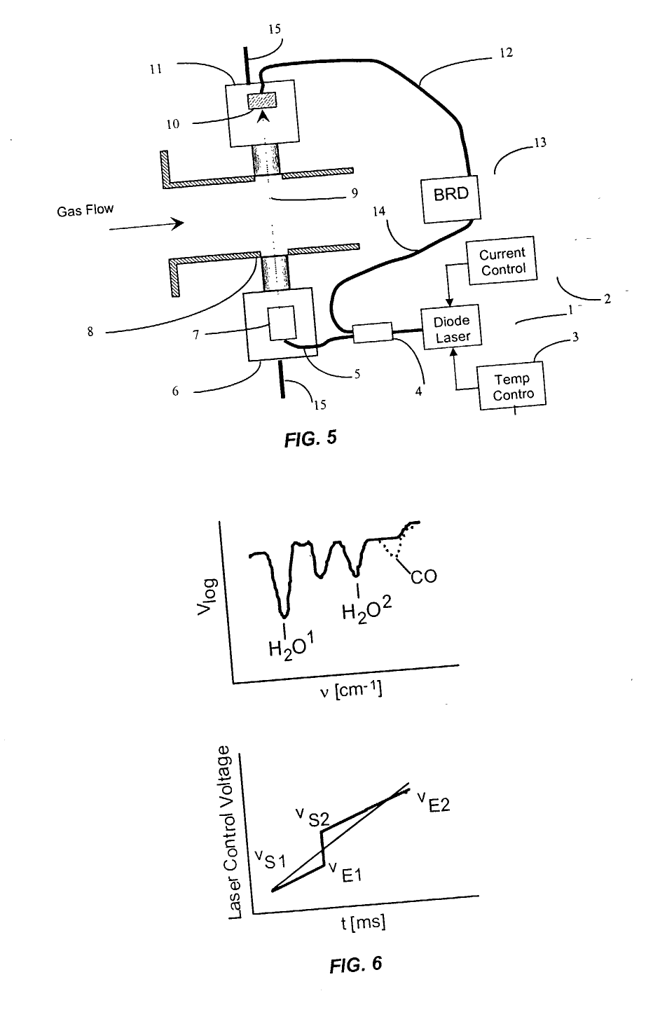

Implementation of the preferred monitoring method on a combustion process includes the following basic elements illustrated in FIG. 5. A single diode laser 1 that is referenced to ITU-GRID channel 21 is used in this embodiment. The laser wavelength scanning start position is stabilized and adjusted and set by the temperature controller 3 such as Melles Griot Carlsbad Calif., model 56DLD403. Wavelength scanning of the laser is controlled by the current controller 2 that can scan across the whole wavelength range to monitor the selected H₂ O and CO lines.

If the additional H₂O line is monitored, the method unnecessarily taxes the system resources. Preferably, therefore, the laser is jump-scanned, as shown in FIG. 6, where only the targeted absorption transitions are monitored, as indicated by the H₂O lines marked 1 and 2. Data for the unmarked H₂O line that resides between the two selected lines is not acquired, thus improving the system resources. The output of diode laser 1 is fiber optically coupled by Gould Electronic Millersvile Md., model 22-10676040-4687 and transported to coupler 4 that splits the input energy to direct 30% to the process and 70% is used as a reference, in the example illustrating the use of the BRD circuit. The 30/70 split is a characteristic of the BRD method for normal operation. However, the proportion of power split can be application dependent. Alternatively, if a modulation approach is used, the split portion can be used for a reference cell to line-lock the laser.

If multiple lasers are used, the divider would be n×2, where n is the number of inputs with 2 outputs. The output of the coupler is transported by a single mode fiber (OZ Optics, Ontario, Canada) having a 9 micron core with FC/APC connector/collimator ends 5. The connector/collimator ends 5 can be hundreds of meters in length, facilitating placement of the sensitive laser and associated electronics in a secure, well controlled environment away from the harsh environment typically found near industrial combustion processes. A beam launch module 6 is mounted at the monitoring point of interest 8 on the process using water or gas cooled pipes. The beam exits fiber optic 5 and propagates through shaping and collimating optics 7 that produces the desired beam diameter and divergences.

For industrial processes where particulate matter is present, a typical beam diameter ranging from 1 to 9 centimeters (cm) is preferred. The expanded beam diameter provides a spatial averaging effect that improves the signal-to-noise for particle-laden flows and reduces the angular divergence, which reduces beam steering due to temperature gradients. Beam 9 propagates through the cooled pipe on the launch side and traverses across the process where it is received by the detector module 11 mounted opposite beam launch module 6. Both the beam launch module 6 and detector module 11 can be purged with a gas 15 if needed. Any gas can be used provided it does not contain the gaseous species being monitored or interferes with resolving the absorption line shape of interest.

For example, N₂ or air can be used if only CO monitoring is being conducted. The process gas itself can even be used provided it is cleaned (free of particulate matter) and dry (moisture removed) and does not contain any absorbing gaseous species. In addition, the process gas must be cooled to an acceptable temperature dictated by the components used in the module. Detector module 11 receives the beam and directs it to detector 10, which consists of one or more of the following elements: a narrowband pass filter, dispersing elements or narrowband reflectors to selectively direct the laser radiation to the InGaAs photo detector, e.g., Fermionics of Simi Valley Calif. model FD3000W.

As shown in FIG. 5, the output of detector 12 is sent to an absorption measurement device, such as a balanced radiometric detector (BRD) 13 along with the split portion of the beam 14 from the coupler 4, which is used as a reference. The BRD 14 contains noise canceling electronic circuitry whose output gives the log ratio measured intensity from the detector 12 and the reference intensity 14. The output from 14 is processed in a computer 17 where the number density of the measured species can be obtained after first determining the gas temperature. The BRD approach's advantages are described in the literature. See, e.g., Allen, M. G., DIODE LASER ABSORPTION SENSORS FOR GAS-DYNAMIC AND COMBUSTION FLOWS, Measurement Science and Technology, Vol. 9, pg. 545-562 (1998) and Sonnenfroh, et al., AN ULTRASENSITIVE DETECTION TECHNIQUE FOR TUNABLE DIODE LASER SPECTROMETERS: APPLICATION TO DETECTION OF NO₂ AND H₂O, Proceedings of S.P.I.E., Vol. 2834, pg. 57-66 (1996).

Additionally, other techniques can be found in the literature such as direct absorption, frequency modulation, wavelength modulation, noise subtraction, etc., that can be used to conduct absorption measurements with diode lasers. The basic principal in all these methods is the same, i.e., a beam is generated by a diode laser and propagated across the process, and the absorbance measured. Variations in the different techniques reside in how one monitors and interprets the absorption signals. Independent of the technique chosen, selection of the laser at ITU-GRID channel 21 can be used to acquire multiple H₂O lines and a single (3,0) R20 CO line.

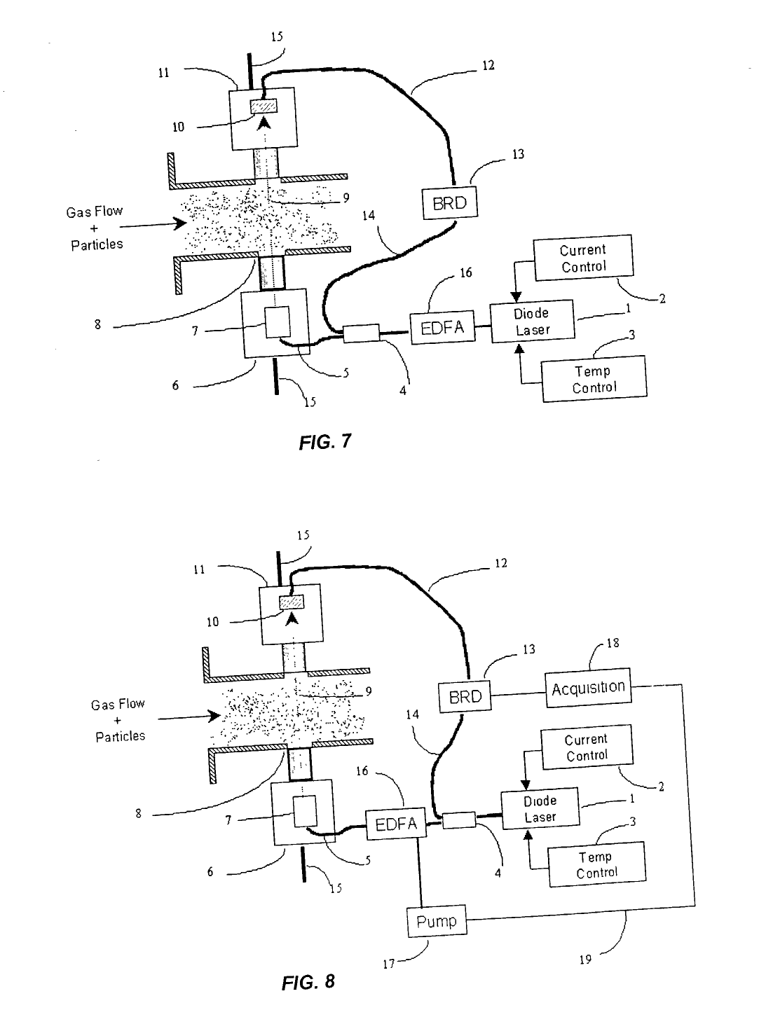

A second aspect of the invention incorporates the use of the EDFA 16 in line between the laser output and the beam splitter 4, as shown in FIG. 7. In this case, the amplified beam is transported directly to the process launch optic by fiber 5 and transport by fiber 14 to the BRD 13 as a reference. Laser power adjustment is required to prevent the reference detector on the BRD or the signal detector from saturating. The laser power measured by detector 10 will be attenuated due to the particles in the gas stream. For a process operating at near steady state conditions, e.g., glass-melting tank, an average of the particle density spanning a line-of-sight path through the process will be nearly constant. Launching a laser beam across process will result in an average attenuation of the power collect on detector 10. In this case, the desired signal level is adjusted by amplifying the laser beam through regulation of the pump laser power used by the EDFA. Balancing of the reference power is then conducted by selection of the appropriate beam splitter, e.g., in the normal configuration using a BRD technique, a 70/30 splitter is used with 70% of the power directed to the reference detector and 30% to the launch module. The proportion of laser power split is not fixed, and can be adjusted accordingly for the appropriate absorption measurement technology used.

A third aspect of the invention uses the same configuration in FIG. 7 but with a multiplexed splitter for n number of process monitoring points. In this case, the EDFA increases the output power that can then be distributed evenly or unevenly to n number of points. Utilizing a multiple point measurement scheme with one laser system reduces the overall cost by avoiding duplication.

A fourth aspect of the invention is using a modified configuration shown in FIG. 8. In this case, the signal from the acquisition system 18 is sent to the pump laser 17 to vary the power and thus vary the resulting gain from the EDFA. The addition of the feedback gain control will allow the laser power to adjust with the process conditions based on the amount of baseline attenuation or gain detected. Dynamic processes, e.g., EAF, will experience large variations in the particle density throughout a batch cycle. At times little or no particles may be present allowing a fully amplified beam to focus onto the detector, resulting in signal saturation or detector damage. Other times the particle loading can be so high to fully attenuate the beam before exiting the process. Compensating for these process variations will extend the dynamic measurement capabilities.

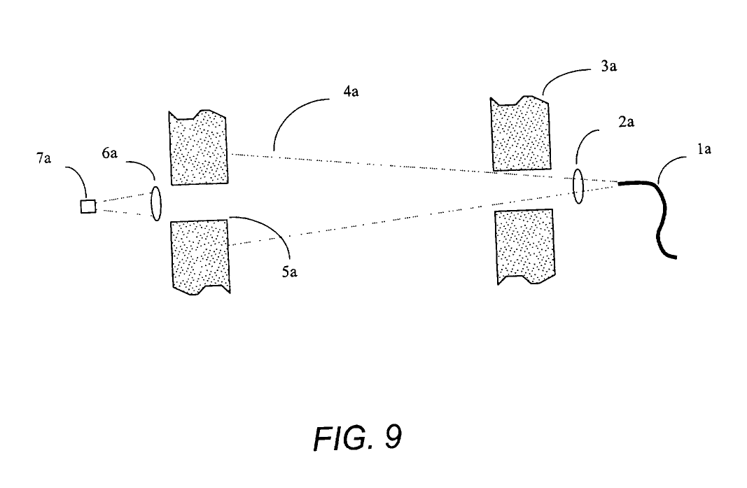

A fifth aspect of the invention is shown in FIG. 9, illustrating the use of over expanding the beam diameter on the receiving side. In this case, the amplified beam 1a from the EDFA is launched using an optic 2a to expand the beam to a desired diameter 4a at the receiving side 5a. The beam is then collected by element 6a that can be a lens, or combination of lenses, or any optical element that can collect the light and focus it to detector 7a. This approach is beneficial for cases where beam movement due to either mechanical vibration or beam steering from thermal gradients is present. In addition, the accuracy of the line-of-sight optical access is less critical, since the expanded beam will intercept the receiving aperture. The additional power provided by the EDFA in this approach compensates for the losses resulting from over expansion of the beam at the receiving aperture.

Note that the EDFA can operate at either continuous power or at dynamic power modes, depending on the specific application desired. Specifically, the EDFA can be operated in a dynamic mode with feedback to the EDFA pump laser to vary the laser output power based on the process conditions, e.g., as where the particle density is high.

Thus, a method for monitoring the high temperature reducing combustion atmosphere in a combustion process is disclosed. First, a spectral region for monitoring CO and H₂O is identified. A laser wavelength is scanned so that a complete absorption transition includes a portion of the baseline. A laser is then referenced to an ITU-GRID. An output signal is generated from the laser and directed to a coupler to split the output signal in a predetermined ratio to a first component and a second component. The first component is directed to optics where it is shaped and collimated and then directed across a sample to be monitored to a detector that generates a measured output. The second component is directed to an absorption measurement device. The measured output is compared with the second component, and the temperature of the atmosphere and the concentration of the CO present in the atmosphere is calculated.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for monitoring the high temperature reducing combustion atmosphere in a combustion process comprising, in combination:
identifying a spectral region for monitoring CO and H₂O;
scanning a laser wavelength so a complete absorption transition includes a portion of the baseline;
referencing a laser to an ITU-GRID;
generating an output signal from the laser and directing it to a coupler to split the output signal in a predetermined ratio to a first component and a second component;
directing the first component to shaping and collimating optics;
directing the second component to an absorption measurement device;
shaping and collimating the first component and directing it across a sample to be monitored to a detector that generates a measured output;
comparing the measured output with the second component; and
calculating the temperature of the atmosphere and the concentration of the CO and H₂O present in the atmosphere.

2. The method of claim 1, further comprising jump scanning the laser whereby only targeted absorption transitions are monitored.

3. The method of claim 1, wherein the absorption measurement device is a balanced radiometric detector (BRD).

4. The method of claim 2, wherein the absorption measurement device is a balanced radiometric detector (BRD).

5. The method of claim 1, wherein the laser is a single diode laser.

6. The method of claim 2, wherein the laser is a single diode laser.

7. The method of claim 3, wherein the laser is a single diode laser.

8. The method of claim 1, further comprising selecting a single, tunable, diode laser to enable monitoring of two H₂O absorption lines and a single CO absorption line in the 1.56 μm spectral region.

9. The method of claim 1, further comprising aligning the laser with an ITU-GRID channel in the c-band.

10. The method of claim 1, further comprising aligning the laser with an ITU-GRID channel in the l-band.

11. The method of claim 1, further comprising directing the output signal from the laser to an amplifier before directing it to the coupler.

12. The method of claim 11, wherein the amplifier is an erbium doped fiber amplifier (EDFA).

13. The method of claim 12, wherein the EDFA is operated in a dynamic mode with feedback to an EDFA pump laser, whereby the laser power output is varied according to process conditions.

14. The method of claim 1, further comprising selecting the absorption lines in a spectral interval sufficiently narrow to permit a single DFB laser to access the lines in a single sweep of the laser wavelength.

15. The method of claim 1, further comprising selecting the absorption lines to be about 6405.92 and 6406.53 cm⁻¹ for H₂O and about 6406.7 cm⁻¹ for CO.

16. The method of claim 15, further comprising selecting the absorption lines to be about 6405.92 and 6406.53 cm⁻¹ for H₂O and about 6406.7 cm⁻¹ for CO.

17. A method for monitoring the high temperature reducing combustion atmosphere in a combustion process comprising, in combination:
identifying a spectral region for monitoring CO and H₂O;
scanning a laser wavelength so a complete absorption transition includes a portion of the baseline;
referencing a tunable, single diode laser to an ITU-GRID;
generating an output signal from the laser and directing it to a coupler to split the output signal in a predetermined ratio to a first component and a second component;
directing the first component to shaping and collimating optics;
directing the second component to a balanced radiometric detector (BRD);
shaping and collimating the first component and directing it across a sample to be monitored to a detector that generates a measured output;
comparing the measured output with the second component; and
calculating the temperature of the atmosphere and the concentration of the CO and H₂O present in the atmosphere.

18. The method of claim 17, further comprising selecting a single, tunable, diode laser to enable monitoring of two H₂O absorption lines and a single CO absorption line in the 1.56 μm spectral region.

19. The method of claim 17, further comprising aligning the laser with an ITU-GRID channel in the c-band.

20. The method of claim 17, further comprising aligning the laser with an ITU-GRID channel in the l-band.

21. The method of claim 17, further comprising directing the output signal from the laser to an amplifier before directing it to the coupler.

22. The method of claim 17, wherein the amplifier is an erbium doped fiber amplifier (EDFA).

23. The method of claim 22, wherein the EDFA is operated in a dynamic mode with feedback to an EDFA pump laser, whereby the laser power output is varied according to process conditions.

24. The method of claim 17, further comprising selecting the absorption lines in a spectral interval sufficiently narrow to permit a single DFB laser to access the lines in a single sweep of the laser wavelength.

25. The method of claim 17, further comprising selecting the absorption lines to be about 6405.92 and 6406.53 cm⁻¹ for H₂O and about 6406.7 cm⁻¹ for CO.

26. The method of claim 25, further comprising selecting the absorption lines to be about 6405.92 and 6406.53 cm⁻¹ for H₂O and about 6406.7 cm⁻¹ for CO.

27. A method for monitoring the high temperature reducing combustion atmosphere in a combustion process comprising, in combination:
selecting absorption lines to be about 6405.92 and 6406.53 cm⁻¹ for H₂O and about 6406.7 cm⁻¹ for CO;
selecting a single, tunable, diode laser to enable monitoring of two H₂O absorption lines and a single CO absorption line in the 1.56 μm spectral region;
aligning the laser with an ITU-GRID channel in the c-band;
scanning a laser wavelength so a complete absorption transition includes a portion of the baseline;
referencing the tunable, single diode laser to an ITU-GRID;
generating an output signal from the laser and directing it to an erbium doped amplifier to generate an amplified output signal;
directing the amplified output signal to a coupler to split the output signal in a predetermined ratio to a first component and a second component;
directing the first component to shaping and collimating optics;
directing the second component to a balanced radiometric detector (BRD);
shaping and collimating the first component and directing it across a sample to be monitored to a detector that generates a measured output;
comparing the measured output with the second component; and
calculating the temperature of the atmosphere and the concentration of the CO and H₂O present in the atmosphere.

28. The method of claim 27, wherein the EDFA is operated in a dynamic mode with feedback to an EDFA pump laser, whereby the laser power output is varied according to process conditions.
